(19) United States
(12) Patent Application Publication
(10) Pub. No.: US 2019/0215172 A1
(43) Pub. Date: Jul. 11, 2019

(54) Group Communication Enabled Tool Tips

(71) Applicant: ACTeq, LLC, Katy, TX (US)

(72) Inventors: Damian Hite, Katy, TX (US); Dave Ridyard, Katy, TX (US)

(21) Appl. No.: 15/865,563

(22) Filed: Jan. 9, 2018

(51) Int. Cl. H04L 12/18; G06F 9/451

(52) U.S. Cl. CPC H04L 12/1818; H04L 65/403; H04L 12/1831; G06F 9/453

(57) ABSTRACT

The present invention is directed towards group communication enabled tool tips in software application programs that allows the content of tool tips to be created, extended, and modified by users of the group. This invention advances the common practices of providing software users with context sensitive advice on parameter selection to encompass one or more interactive threads of group communication such as social media conversation. The invention is applicable to software programs whether executed locally or executed remotely and delivered to the user through a browser or remote server window.

### FIELD OF THE INVENTION

This invention generally pertains to the field of tool tips in software application programs and, more particularly, it relates to creating, extending, and modifying group communication enabled tool tips in software application programs.

### BACKGROUND OF THE INVENTION

Software programs often require many complex user inputs. Incorrect user input can lead to errors in program execution. Programmers often attempt to protect against incorrect user input by testing entered values against pre-determined acceptable ranges of values. This testing can reduce the probability of gross errors, but still allow sub-optimal but legal parameters to be accepted. Users can be trained in the optimum selection of parameters, or can read about correct operation in manuals, or on-line help documentation. On-line sources of advice can be inaccurate, particularly when delivered through unauthorized third parties, and furthermore these sources of advice can be annoying to use due to the constant presence of advertising.

In many applications, users may not have time or sufficient interest to locate and read such documentation. For this reason, “tool tips” have been developed to deliver context sensitive information to users as they enter parameters. Tool tips offer guidance on parameter selection for a specific parameter by offering information at, or close to the cursor location, as the cursor passes over a particular parameter entry field. In the conventional manifestation, the content of a tool tip is static and defined by the software publisher.

Thus, there is a need for group communication enabled tool tips in software application programs that allow the content of tool tips to he created, extended, and modified by users of the group thus unlocking the power of the entire user community to share additional advice on parameter selection.

Numerous innovations have been provided in prior art that are adapted to the field of tool tips used in software programs. Even though these innovations may be suitable for the specific purposes which they address, they would not be as suitable for the purposes of the present invention,

For example, U.S. Pat. No. 7,669,125 to Smirnov discloses about a method and apparatus for adaptively generating a tooltip to be displayed on the display screen in association with the object based on the current state of the object, the tooltip being generated when the user places the pointer over the object; wherein the tooltip contains help text that depends on the current state of the object.

US Patent Application No. 20,110,314,415 to Fitzmaurice et al. discloses about a computer-implemented method for providing custom tooltips to an end-user of a software application, wherein the custom tooltip includes one or more custom tooltip entries associated with the selected UI element created by one or more users. The one or more custom tooltip entries are received from a tooltip database that stores tooltip information associated with the selected UI element

U.S. Pat. No. 8,281,242 to Gomes et al. discloses about a system and method for debugging a program comprising editable data tooltips, wherein the tooltip includes a first portion, e.g., context sensitive control, displaying the value and to receive the second user input modifying the value, and a second portion, e.g., text indicator, displaying non-editable information related to the expression.

U.S. Pat. No. 7,685,519 to Duncan et al, discloses about a method and apparatus for providing a customizable content tooltip having a customization control that, when activated, allows a user to choose and/or edit the content displayed by the customizable content tooltip,

It is apparent now that numerous innovations for tool tips have been developed in the prior art that are adequate for various purposes. Furthermore, even though these innovations may be suitable for the specific purposes to which they address, accordingly, they would not be suitable for the purposes of the present invention as heretofore described. Thus, a need for group communication enabled tool tips in software application programs that allows the content of tool tips to be created, extended, and modified by users of the group thus unlocking the power of the entire user community to share additional advice on parameter selection is needed.

### SUMMARY OF THE INVENTION

The present invention discloses about dynamic tool tips in software application programs, wherein the system incorporates a software application program comprising group communication enabled tool tips, wherein the software application program can be executed locally or remotely and delivered to the user through a browser or remote server and allowing dynamic modification of content of the group communication enabled tool tips by the users of the software application, wherein accessing to view or edit content of the tool tips is controlled by one or more community moderators.

In view of the foregoing, it is therefore an object of the present invention to provide a dynamic tool tip that allows the content of tool tips to be created, extended and modified by users thus unlocking the power of the entire user community to share additional advice on parameter selection.

It is another object of the present invention to show expanded tool tips only if requested through some software defined trigger such as a hot key.

It is another object of the present invention to provide an icon such as a pencil icon indicating that a particular portion of the tool tip is editable by the current user.

It is another object of the present invention to provide a group communication enabled tool tips that includes advertising content provided by the software publisher.

It is still another object of the present invention to provide group communication enabled tool tips, wherein the capability to modify the group communication enabled tool tips may be restricted to a specific community or to authorized users.

It is still another object of the present invention to provide group communication enabled tool tips, wherein a moderator can control either viewership or authorship of content or both viewership and authorship of content of the group communication enabled tool tips to approve, reject, modify, or show content suggested by the users within a community.

It is still another object of the present invention to provide a group communication enabled tool tips, wherein the group communication enabled tool tips may be associated with a specific project having software application programs in fields such as engineering, science, financial, accounting, business intelligence, supply chain management, customer relationship management.

Other features and aspects of the invention will become apparent from the following detailed description, taken in conjunction with the accompanying drawing, which illustrates, by way of example, the features in accordance with embodiments of the invention. The summary is not intended to limit the scope of the invention, which is defined solely by the claims attached hereto.

### BRIEF DESCRIPTION OF THE DRAWING

The present invention, in accordance with one or more embodiments, is described in detail with reference to the following figures. The drawing is provided for purposes of illustration only and merely depicts typical or example embodiments of the invention. The drawing is provided to facilitate the reader's understanding of the invention and shall not be considered limiting of the breadth, scope, or applicability of the invention.

FIG. 1 is an illustration of an interface showing a group communication enabled tool tip in a software application program.

The figure is not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE INVENTION

From time-to-time, the present invention is described herein in terms of examples. Description in terms of these examples is provided to allow the various features and embodiments of the invention to be portrayed in the context of an exemplary application. After reading this description, it will become apparent to one of ordinary skill in the art how the invention can be implemented in different and alternative applications.

Unless defined otherwise, all technical and scientific terms used herein have the same meaning as is commonly understood by one of ordinary skill in the art to with this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention is directed towards a method and system fur group communication enabled tool tips access and control in software application programs that allows the content of tool tips to be created, extended, modified, and shared by users of the group thus unlocking the power of the entire user community to share additional advice on parameter selection.

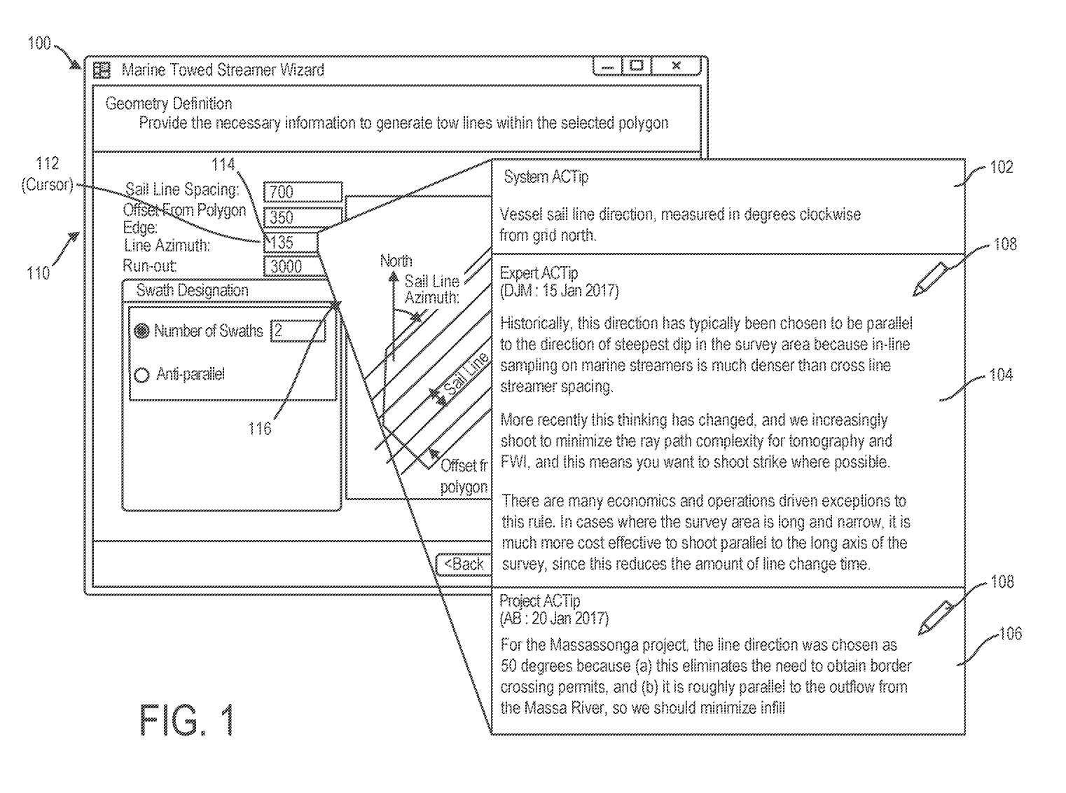

As shown in the FIG. 1, illustrating an interface 100 showing group communication enabled tool tips (104 and 106) along with a traditional tool tip 102 in a software application program 110 showing an exemplary manifestation of the present invention, in which the group communication enabled tool tips (104 and 106) along with custom tool tip 102 are referred to as ACTips (102, 104 and 106). Further group communication includes social media conversation thus unlocking the power of the entire social media to share additional advice on parameter selection. When the cursor 112 is placed over a parameter entry field 114, the traditional tool tip 102 is displayed, as indicated by the “System ACTip” as shown in the FIG. 1, further group communication enabled tool tips (104 and 106) are additionally displayed simultaneously as extended information below the “System ACTip” 102. However, since group communication enabled tool tips (104 and 106) can consume significant screen area 116, it is assumed that most users would prefer to show expanded tool tips only if requested through some software defined trigger such as a hot key (not shown). When the user enacts the appropriate input, the group communication enabled or social media enabled tool tips (104 and 106) appear along with a traditional tool tip 102. A pencil icon 108 indicates that a particular tool tip is editable by the current authorized user.

According to an exemplary embodiment of the present invention as the extended information may be categorized in one or more groups..fn the example shown in FIG, 1, two forms of additional information are shown. The “Expert ACTip” 104 can he provided by an expert user describing how the correct parameter value should be chosen. The “Project ACTip” 106 can be provided by any prior user of the software program to provide information relating to the selection of the parameter value for the current project. Project ACTips 106 may be stored with a project so that future users may understand the thinking of earlier users in selecting a particular parameter. This archival audit trail functionality can be very useful in large corporations with complex projects and significant number of users.

The Expert ACTip 104 provides more general advice, but it may also offer proprietary and valuable information and thus it may be appropriate to restrict viewing and/or editing of content to a specific community, defined by corporate affiliation, rank or some other community affiliation. A particular user may have access to group communication enabled tool tips defined for multiple communities. For example he or she may have access to his company's internal tool tips and also tool tips made available through some professional society. Expert ACTips 104 allow inexperienced users to benefit from the experience of entire communities of users.

Access to view or edit tool tips (102, 104 and 106) content may be controlled by one or more community moderators (not shown). Some communities may wish to tightly control both viewership and authorship of content while other communities may be more comfortable with more open exchange of ideas.

Although one potential benefit of ACTips (102, 104, and 106) is the freedom from advertising for the users while using the tool tips, this is a decision for the software publisher, who may choose to place advertising material in the ACTips (102, 104, and 106) if he or she feels that the commercial advantage outweighs the degradation of the user experience.

Group communication enabled tool tips (104 and 106) can create value in any application from engineering, science, financial, accounting, business intelligence, supply chain management, customer relationship management etc.

Only two types of group communication enabled tool tips (1.04 and 106) are described as examples in the FIG. 1, however several other types of group communication enabled tool tips from other professional groups and/or several social communities can be provided along with the traditional tool tip 102. Further a group communication tool tip can he selected from a group of all available group communication tool tips to be displayed at a time as per the user request. Several other modifications to selection, display and arrangement of the group communication tool tips can be achieved without departing from the scope and spirit of the present invention.

According to an aspect of the present invention, a software application program 110 comprising group communication enabled tool tips (104 and 106), wherein the software application program 110 can be executed locally or remotely and delivered to the user through a browser or remote server and allowing dynamic modification of content of the group communication enabled tool tips (104 and 106) by the users of the software application 110, wherein accessing to view or edit content of the tool tips (102, 104, and 106) is controlled by one or more community moderators (not shown).

According to another aspect of the present invention, the method of providing software application users with context sensitive advice on parameter selection to encompass one or more interactive threads of communication of one or more group of users, wherein the method comprising: providing one or more group communication enabled tool tips (104 and 106) to the users of the software application 110, thereby unlocking the power of the user community to share additional advice on parameter selection; creating the contents of the tool tips (104 and 106) by one or more authorized users; extending the contents of the tool tips (104 and 106) to the users, when requested through some software defined trigger (not shown); showing an edit icon 108 on each of the expanded tool tips (104 and 106) to the current authorized users, thereby allowing modification of the content of the tool tips (104 and 106) by the authorized users; and access to view or edit content of the tool tips (104 and 106) is controlled by one or more community moderators (not shown).

According to another aspect of the present invention, the software application program 110 to receive context sensitive advice on parameter selection to encompass one or more interactive threads of communication of one or more groups of users near to the cursor 112 location as the cursor 112 passes over a particular parameter entry field 114 of the software program 110, wherein the software application program 110 comprising; at least one tool tip, wherein the tool tip includes a first portion showing a non-editable traditional tool tip 102, a second portion showing a group communication enabled expert tool tip 104, which is editable by an authorized expert user describing correct parameter value selection procedure dynamically and a third portion showing a group communication enabled project tool tip 106, which is editable by an authorized earlier user providing information relating to the selection of the parameter value for the current project; a software defined trigger (not shown), wherein the trigger allows to expand the second and third portion of the tool tip (104 and 106) to authorized users; and one or more community moderators (not shown) to control accessing to view or edit content of the group communication enabled tool tips by the users.

According to another aspect of the present invention, the group communication enabled tool tips (104 and 106) may include advertising content, which can be provided by the software publisher.

According to another aspect of the present invention, the visibility of certain group communication enabled tool tips (104 and 106) may be restricted to a specific community. Further the capability to modify the group communication enabled tool tips (104 and 106) may be restricted to a specific community or to an authorized user.

According to another aspect of the present invention, the moderator (not shown) can control either viewership or authorship of content or both viewership and authorship of content of the group communication enabled tool tips (104 and 106) to approve, reject, modify or show content suggested by the users of a community. Further the moderator can approve, reject or modify content suggested by users of a community.

According to another aspect of the present invention, the group communication enabled tool tip 104 is an “Expert ACTip” describing correct parameter value selection procedure, thereby allowing inexperienced users to benefit from the experience of the entire communities of users.

According to another aspect of the present invention, the group communication enabled tool tip 106 is a “Project ACTip” providing information relating to the selection of the parameter value for the current project.

According to another aspect of the present invention, the software defined trigger is a hot key (not shown).

According to another aspect of the present invention, multiple tool tips may be presented to a user based upon membership of multiple user communities.

According to another aspect of the present invention, the group communication enabled tool tips (104 and 106) may be associated with a specific project having software application programs in the field of engineering, science, financial, accounting, business intelligence, supply chain management, customer relationship management etc.

While various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can he implemented using a variety of alternative architectures and configurations.

Although the invention is described above in terns of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and Whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of providing software application users with context sensitive advice on parameter selection to encompass one or more interactive threads of communication of one or more group of users, wherein the method comprising:
providing one or more group communication enabled tool tips to the users of the software application, thereby unlocking the power of the user community to share additional advice on parameter selection.

2. The method of claim 1 in which one or more authorized users create contents of the tool tips

3. The method of claim 1 in which the user can extend the contents of the tool tips when requested through some software defined trigger.

4. The method of claim 3, wherein the software defined trigger is a hot key.

5. The method of claim 3 in which only authorized users are allowed to edit the content of the tool tips.

6. The method of claim 5 in which the user's ability to edit the content of the tool tips is indicated by the presence of an edit icon.

7. The method of claim 5 in which the distribution of user updated tool tip content is controlled by one or more community moderators.

8. The method of claim 7, wherein the moderator can approve, reject or modify content suggested by users of a community.

9. The method of claim 1, wherein the group communication enabled tool tip is an “Expert ACTip” describing correct parameter value selection procedure, thereby allowing inexperienced users to benefit from the experience of the entire communities of users.

10. The method of claim 1, wherein the group communication enabled tool tip is a “Project ACTip” providing information relating to the selection of the parameter value for the current project.

11. The method of claim 1, wherein the visibility of certain tool tips may be restricted to a specific community.

12. The method of claim 1, wherein the capability to modify tool tips may be restricted to a specific community or to an authorized user.

13. The method of claim 1, wherein multiple toot tips may be presented to a user based upon membership of multiple user communities.

14. The method of claim 1, wherein the tool tip includes advertising content provided by the software publisher.

15. A software application program comprising group communication enabled tool tips, wherein the software application program can be executed locally or remotely and delivered to the user through a browser or remote server and allowing dynamic modification of content of the group communication enabled tool tips by the users of the software application, wherein accessing to view or edit content of the tool tips is controlled by one or more community moderators.

16. The software application program of claim 15, wherein the visibility of certain tool tips may be restricted to a specific community.

17. The software application program of claim 15, wherein the capability to modify tool tips may be restricted to a specific community or to an authorized user,

18. The software application program of claim 15, wherein the tool tip includes advertising content provided by the software publisher.

19. A software application program to receive context sensitive advice on parameter selection to encompass one or more interactive threads of communication of one or more group of users near to the cursor location as the cursor passes over a particular parameter entry field of the software program, wherein the software application program comprising:
at least one tool tip, wherein the tool tip includes a first portion showing a non-editable traditional tool tip, a second portion showing a group communication enabled expert tool tip, which is editable by an authorized expert user describing correct parameter value selection procedure dynamically and a third portion showing a group communication enabled project tool tip, which is editable by an authorized earlier user providing information relating to the selection of the parameter value for the current project;
a software defined trigger, wherein the trigger allows to expand the second and third portion of the tool tip to authorized users; and
one or more community moderators to control accessing to view or edit content of the group communication enabled tool tips by the users.

20. The software application program of claim 19, wherein the group communication enabled tool tips includes advertising content provided by the software publisher.

21. The software application program of claim 19, wherein the visibility of certain group communication enabled tool tips may be restricted to a specific community.

22. The software application program of claim 19, wherein the capability to modify the group communication enabled tool tips may be restricted to a specific community or to an authorized user.

23. The software application program of claim 19, wherein the moderator can control either viewership or authorship of content or both viewership and authorship of content of the group communication enabled tool tips to approve, reject, modify or show content suggested by the users of a community.

24. The software application program of claim 19, wherein the group communication enabled tool tips may he associated with a specific project having software application programs in the field of engineering, science, financial, accounting, business intelligence, supply chain management, customer relationship management or any other activity in which collaboration may be required.
